(19) United States
(12) Patent Application Publication
(10) Pub. No.: US 2026/0158981 A1
(43) Pub. Date: Jun. 11, 2026

(54) AIR SUPPORT SYSTEM

(71) Applicants: HYUNDAI MOTOR COMPANY, Seoul (KR); KIA CORPORATION, Seoul (KR); HYUNDAI TRANSYS INC., Seosan-si (KR)

(72) Inventors: Sang Uk Yu, Hwaseong-si (KR); Soo Hyun Moon, Hwaseong-si (KR); Seung Young Lee, Hwaseong-si (KR); Ji Hwan Kim, Hwaseong-si (KR); Ki Ryung Lee, Hwaseong-si (KR); Dong Hoon Keum, Hwaseong-si (KR); Tae Hoon Lee, Hwaseong-si (KR); So Young Yoo, Hwaseong-si (KR); Hong Noh Park, Hwaseong-si (KR); Seong Yun Yeo, Hwaseong-si (KR)

(73) Assignees: HYUNDAI MOTOR COMPANY, Seoul (KR); KIA CORPORATION, Seoul (KR); HYUNDAI TRANSYS INC., Seosan-si (KR)

(21) Appl. No.: 19/196,486

(22) Filed: May 1, 2025

(30) Foreign Application Priority Data
Dec. 6, 2024 (KR) 10-2024-0180479

(51) Int. Cl. B60N 2/90

(52) U.S. Cl. CPC B60N 2/914

(57) ABSTRACT

An air support system includes an outer plate having a lateral portion in which a recessed space is formed. The air support system further includes an inner plate hingedly coupled to the outer plate and configured to be rotatable about the outer plate, where the inner plate includes a protruding portion protruding toward the recessed space of the outer plate. The air support system also includes a bladder part provided between the outer plate and the inner plate. The bladder part includes a sub-part disposed within the recessed space of the outer plate, and a main part disposed on a lower surface of the inner plate, where the inner plate is configured to rotate based on expansion of the sub-part.

### CROSS-REFERENCE TO RELATED APPLICATION

This application claims under 35 U.S.C. § 119(a) the benefit of and priority to Korean Patent Application No. 10-2024-0180479 filed on Dec. 6, 2024, the entire contents of which are incorporated herein by reference.

### BACKGROUND

### Technical Field

The present disclosure relates to an air support system capable of being applied to a seat.

### Background Art

Seats in vehicles, chairs in offices, medical chairs, and the like may implement various functions by using pressure of a fluid, such as air. For example, these functions include adjusting a height of a seat, adjusting a backrest angle, and supporting lumbar vertebrae. A seat for a vehicle is described more specifically. Segmented cushions may be provided in a seat back frame to implement the lumbar support function, and a fluid may be injected into the cushion, which constitutes a lumbar support, under the control of an occupant to appropriately support lumbar vertebrae.

The above information in this Background section is only for enhancement of understanding of the background of the disclosure. Therefore, the Background section may contain information that does not form the prior art that is already known to a person of ordinary skill in the art.

### SUMMARY

In a system that supports or presses a user's body by using pressure of a fluid, a period of time is required to suck or supply the fluid and establish appropriate pressure. As the period of time increases for establishing the appropriate pressure capable of supporting the user's body, marketability deteriorates. In particular, when the user controls the system, an air support system that can respond quickly is required.

Technical problems to be solved by the present disclosure are not limited to the above-mentioned technical problems, and other technical problems, which are not mentioned above, may be clearly understood from the following descriptions by those having ordinary skill in the art to which the present disclosure pertains.

The present disclosure has been made in an effort to solve the above-described problems associated with the prior art. The present disclosure provides an air support system. The air support system includes an outer plate having a lateral portion in which a recessed space is formed. The air support system further includes an inner plate hingedly coupled to the outer plate and configured to be rotatable about the outer plate, where the inner plate includes a protruding portion protruding toward the recessed space of the outer plate. The air support system also includes a bladder part provided between the outer plate and the inner plate. The bladder part includes a sub-part disposed to be positioned within the recessed space of the outer plate, and a main part disposed on a lower surface of the inner plate, where the inner plate begins to rotate based on expansion of the sub-part.

In an embodiment, the outer plate may be fixedly coupled to a seat frame that defines an external shape of a seat.

In an embodiment, the outer plate may be provided on a seat back frame, a seat cushion frame, or both the seat back frame and the seat cushion frame.

In an embodiment, the bladder part may rotate the inner plate by sucking (i.e., intaking) or discharging a fluid.

In an embodiment, the air support system may include a pneumatic part configured to supply a fluid into the bladder part or discharge the fluid accommodated in the bladder part. The pneumatic part may be connected to the sub-part of the bladder part and may supply the fluid to the sub-part or may discharge the fluid accommodated in the sub-part.

In an embodiment, the pneumatic part may include a pump configured to pressurize and transmit the fluid and a tube configured to supply the fluid pressurized from the pump into the bladder part or discharge the fluid accommodated in the bladder part.

In an embodiment, the pneumatic part may further include a valve connected to the tube and a valve controller configured to supply the fluid into the bladder part or discharge the fluid accommodated in the bladder part by adjusting an opening degree of the valve.

In an embodiment, the sub-part may be expanded by the fluid sucked or supplied into the sub-part. After the sub-part is expanded, the sub-part may push the protruding portion of the inner plate, such that the inner plate may begin to rotate.

In an embodiment, the main part may be expanded after the sub-part sucks or intakes the fluid. After the main part is expanded, the inner plate may be supported by the main part.

In an embodiment, the sub-part may be thermally bonded to the main part, such that the sub-part and the main part may communicate with each other through a thermally bonded portion.

In an embodiment, the recessed space may include a plurality of recessed spaces, and the plurality of recessed spaces may be formed in the outer plate. The protruding portion may include a plurality of protruding portions, and the plurality of protruding portions may be formed on the inner plate while corresponding in number to the plurality of recessed spaces. The sub-part may include a plurality of sub-cushions configured to be expanded by a sucked fluid, and the sub-cushions may be respectively disposed in the plurality of recessed spaces. The main part may include a main cushion configured to be expanded by the sucked fluid, and the main cushion may receive the sucked fluid from the plurality of sub-cushions.

In an embodiment, the plurality of sub-cushions may be thermally bonded to the main cushion to constitute the bladder part, such that the plurality of sub-cushions and the main cushion may communicate with one another through the thermally bonded portion.

In an embodiment, the sub-part may have a smaller cross-sectional area than the main part.

According to the air support system of the present disclosure, the bladder part into which the fluid is injected is divided, the injection of the fluid is controlled, and the fluid is supplied to the necessary portion to expand the bladder part, which may contribute to quick responsiveness of the air support system.

The above and other features of the disclosure are discussed below. The effects obtained by the present disclosure are not limited to the aforementioned effects, and other effects, which are not mentioned above, should be clearly understood by those having ordinary skill in the art from the following description.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is an exploded view of the air support system according to an embodiment of the present disclosure;

FIG. 2 is a view illustrating the air support system according to an embodiment of the present disclosure;

FIG. 3 is a view illustrating a cross-section taken along line A-A′ in FIG. 2 in a state in which a bladder part discharges a fluid according to an embodiment of the present disclosure;

FIG. 4 is a view illustrating a cross-section taken along line A-A′ in FIG. 2 in a state in which the bladder part intakes the fluid according to an embodiment of the present disclosure;

FIG. 5 is a view illustrating a cross-section taken along line A-A′ in FIG. 2 in a state in which the bladder part is completely filled by the fluid according to an embodiment of the present disclosure;

FIG. 6 is a view for explaining connection between the bladder part and a pneumatic part of the air support system according to an embodiment of the present disclosure; and

FIG. 7 is a view for explaining a configuration in which the sub-part and a main part of the bladder part are coupled by thermal bonding according to an embodiment of the present disclosure.

It should be understood that the appended drawings are not drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

In the description of the embodiments disclosed in the present specification, the specific descriptions of publicly known related technologies are omitted when it is determined that the specific descriptions may obscure the subject matter of the embodiments disclosed in the present specification. In addition, it should be interpreted that the accompanying drawings are provided only to allow those having ordinary skill in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure. The following disclosure is not intended to limit the present disclosure to the form or particular field described, and it is contemplated that various alternative aspects and modifications of the present disclosure are possible, whether expressly stated or implied in the present specification. Those having ordinary skill in the art to which the present disclosure pertains should recognize that the form and details of the present disclosure may be changed.

The present disclosure refers to certain aspects by reference. However, as should be understood by those having ordinary skill in the art to which this disclosure pertains, various aspects disclosed in the present specification may be modified or otherwise implemented in various other ways without departing from the spirit and scope of the present disclosure. Therefore, the following description should be considered representative and is intended to teach those having ordinary skill in the art to which the present disclosure pertains how to make and use the disclosed embodiments. It should be understood that the forms of disclosure illustrated and described in the present specification are to be taken as representative embodiments. Equivalent elements, materials, processes, or steps may be substituted for those representatively described in the present disclosure. As used in the present disclosure, expressions such as “including,” “comprising,” “incorporating,” “consisting of,” “have,” “is,” and the like should be construed in a non-exclusive manner, i.e., to permit items, constituent elements, or elements not expressly described to be shown. In addition, references to the singular should be interpreted as including references to the plural.

Further, various embodiments disclosed in the present specification are to be taken in an illustrative sense and should not be construed as limiting the scope of the present disclosure. All references to joining (e.g., attached, affixed, coupled, connected, and the like) are intended to assist in understanding the present disclosure only and are not intended to limit the position, orientation, or use of the components or the methods disclosed in the present specification. Therefore, when references to joining are present, these should be interpreted broadly. Furthermore, these references to joining do not assume that two or more elements are directly connected to each other. Additionally, all numerical terms, e.g., “first,” “second,” “third,” “primary,” “secondary,” “major,” or any other generic or numerical term, are to be taken as identifiers only, to assist in understanding the various components, forms, variations, or modifications of the present disclosure, and are not intended to imply any limitation to any component, form, variation, or modification, or any order or preference thereof. These expressions may be used to describe various constituent elements, but the constituent elements are not limited by the corresponding expressions. The corresponding expressions are used only to distinguish one constituent element from another constituent element.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

When a component, device, element, controller, module, or the like (i.e., an apparatus) of the present disclosure is described as having a purpose or performing an operation, function, or the like, the component, device, element, controller, module, or the like should be considered herein as being “configured to” meet that purpose or to perform that operation or function. Each component, device, element, controller, module, or the like may separately embody or be included with a processor and a memory, such as a non-transitory computer readable media, as part of such an apparatus.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. For example, if the device in the figures is rotated 90 degrees, elements described as “upper” or “lower” may then be to the right or the left of other elements. In addition, when an element is referred to as being “between” two elements, the element may be the only element between the two elements, or one or more other intervening elements may be present.

The suffixes “module”, “unit”, “part”, and “portion” used to describe constituent elements in the following description are used together or interchangeably in order to facilitate the description, but the suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

In addition, the term “control unit” or “unit” included in the names is merely a term widely used to name a control device (controller or control unit) for controlling a particular vehicle function but does not mean a generic function unit.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

In any configuration disclosed in the present disclosure, any number of components may be included. The components may include any combination of the features disclosed and be arranged in any configuration disclosed in the present disclosure. The concepts related to the use and operations of the components of the present disclosure, as well as the structure and arrangement of the components of the present disclosure, may be applied not only to particular embodiments discussed in the present disclosure but also to any number of embodiments in any combination. The embodiments including various features of various arrangements are described below with reference to the drawings.

Hereinafter, embodiments according to the present disclosure are described in detail with reference to the accompanying drawings. The same or similar constituent elements are assigned with the same reference numerals regardless of reference numerals, and the repetitive description thereof is omitted.

An air support system according to the present disclosure may be applied to any location where a person may be seated. However, for convenience of description, a configuration is described in which the air support system is installed in a seat for a vehicle. In addition, air may be representatively used as a fluid to be supplied to a bladder part. In other embodiments, other gases such as nitrogen may be used. Nitrogen may be more stable than air and be kept at predetermined pressure, such that the expansion and contraction of the bladder part may be stably controlled even under an environment where temperature varies significantly. In particular, nitrogen causes less oxidation reaction and has high sealability, which may improve durability of the bladder part.

Therefore, the fluid supplied to the bladder part is not limited to air. For example, an alternative gas, such as nitrogen, may be used to improve operational stability of the system.

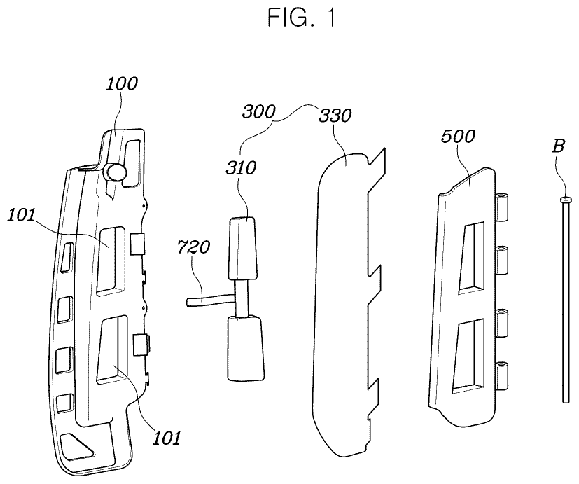

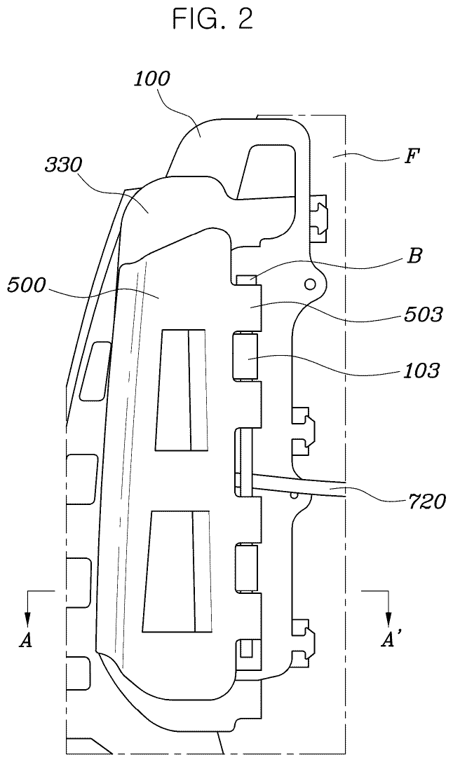

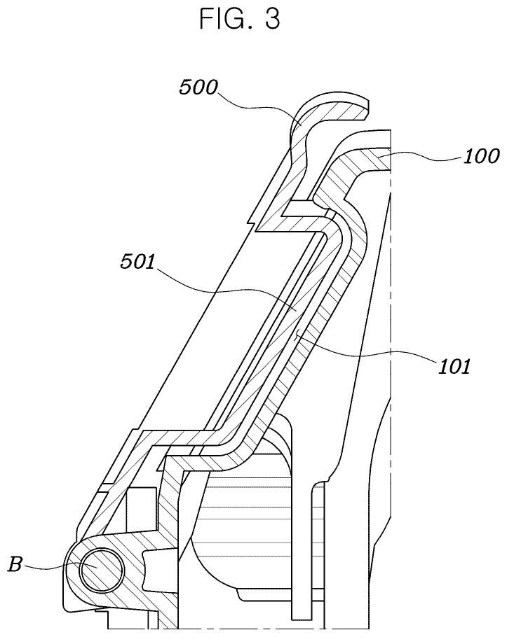

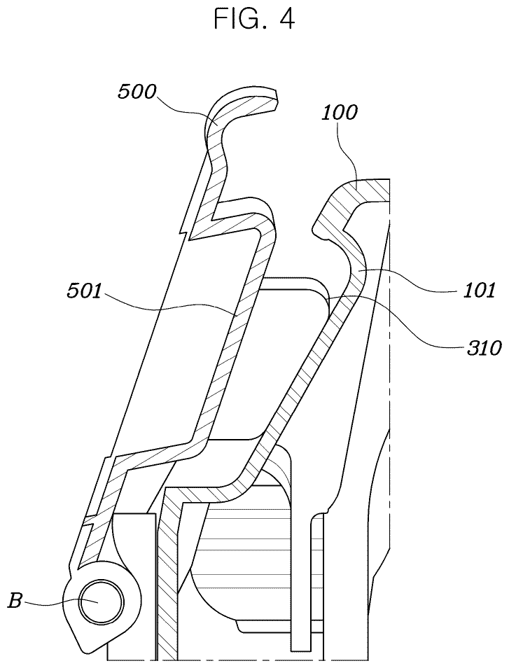

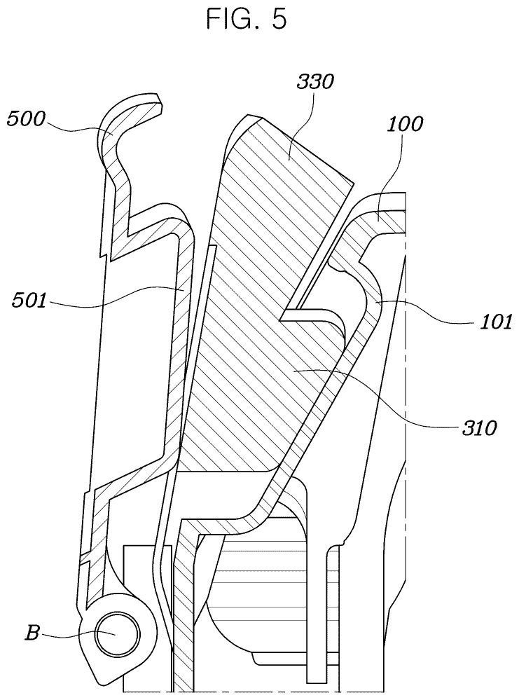

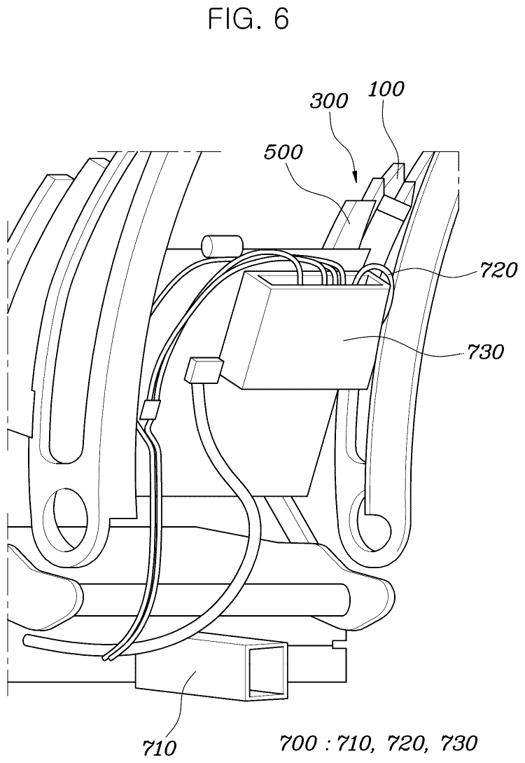

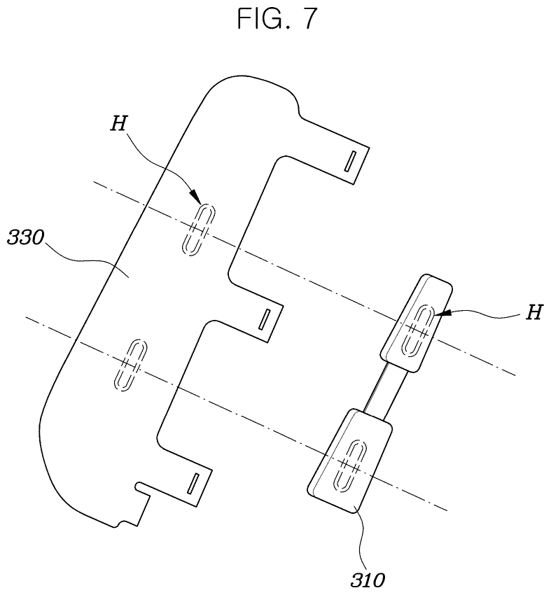

FIG. 1 is an exploded view of the air support system according to an embodiment of the present disclosure. FIG. 2 is a view illustrating the air support system according to an embodiment of the present disclosure. FIG. 3 is a view illustrating a cross-section taken along line A-A′ in FIG. 2 in a state in which a bladder part discharges a fluid, and FIG. 4 is a view illustrating a cross-section taken along line A-A′ in FIG. 2 in a state in which the bladder part sucks or intakes the fluid. FIG. 5 is a view illustrating a cross-section taken along line A-A′ in FIG. 2 in a state in which the bladder part is completely filled by the fluid. FIG. 6 is a view for explaining connection between the bladder part and a pneumatic part of the air support system. FIG. 7 is a view for explaining a configuration in which the sub-part and a main part of the bladder part are coupled by thermal bonding.

As illustrated in FIGS. 1 and 2, an outer plate 100 constitutes an external structure of the air support system, and one or more recessed spaces 101 are formed in a lateral portion of the outer plate 100. The outer plate 100 may support the air support system including a bladder part 300 and an inner plate 500 that is described below and includes a hinge structure configured to facilitate a rotation of the inner plate 500. The outer plate 100 may have a fastening structure so that the outer plate 100 may be attached to a vehicle seat frame F. Further, the outer plate 100 may be made of an alloy or a composite material that is lightweight and durable. For example, aluminum alloy or high-strength plastic may be used as a material of the outer plate 100.

The inner plate 500 is hingedly coupled to the outer plate 100 so that the inner plate 500 may rotate about the outer plate 100. As illustrated in FIG. 3, the inner plate 500 has protruding portions 501 protruding toward the recessed spaces 101 of the outer plate 100. The protruding portions 501 initiate rotation of the inner plate 500 in a particular direction when the bladder part 300 expands. The inner plate 500 may be hingedly coupled to the outer plate 100 by a bolt B. As shown in FIG. 2, a second fastening portion 503 of the inner plate 500 is disposed to overlap a first fastening portion 103 of the outer plate 100 fixedly attached to the vehicle seat frame F. The bolt B is coupled while penetrating the first fastening portion 103 and the second fastening portion 503, such that the inner plate 500 may rotate about the outer plate 100.

The bladder part 300 is positioned between the outer plate 100 and the inner plate 500. The bladder part 300 may expand to induce the rotation of the inner plate 500 and thus allow the inner plate 500 to support a part of the user's body. The bladder part 300 may provide a supporting force. The bladder part 300 includes a sub-part 310 and a main part 330. The sub-part 310 and the main part 330 may be configured separately. The sub-part 310 and the main part 330 may be integrated, and internal spaces thereof may be separated.

As illustrated in FIGS. 4 and 5, the sub-part 310 of the bladder part 300 may be designed to be seated or positioned within the recessed spaces 101 of the outer plate 100, and the bladder part 300 may have a structure fixed to the outer plate 100. The main part 330 of the bladder part 300 is connected to the sub-part 310 and disposed below the inner plate 500. When the main part 330 expands, the bladder part 300 expands together with the sub-part 310 and rotates the inner plate 500. The main part 330 is a main expansion part of the bladder part 300, and the main part 330 may be precisely adjusted to suit the user's body by adjusting the fluid pressure supplied to the main part 330.

The bladder part 300 may include a portion where the sub-part 310 and the main part 330 overlap each other. The rotation of the inner plate 500 may be initiated as the sub-part 310 expands first (i.e., the sub-part 310 begins to expand before the main part 330). For example, the protruding portion 501 of the inner plate 500 is in contact with the portion where the sub-part 310 and the main part 330 overlap each other, such that the inner plate 500 is quickly rotated by the expansion of the sub-part 310. Thereafter, the main part 330 may slowly expand and provide an additional supporting force of the inner plate 500.

In particular, the sub-part 310 has both a smaller cross-sectional area and a smaller overall volume than the main part 330. Therefore, the sub-part 310 may be quickly expanded by a relatively small amount of sucked in (i.e., supplied, provided, taken in, drawn, forced, injected) fluid. Hence, it is possible to generate a rotational force sufficient to rotate the inner plate 500. In particular, the sub-part 310 may expand first at the portion where the sub-part 310 and the main part 330 overlap each other, and the sub-part 310 may induce the quick rotation of the inner plate 500 by pushing the protruding portions 501 of the inner plate 500. In the initial step, this structure may initiate the quick rotation of the inner plate 500, thereby providing immediate supporting force and stability required for the user.

In addition, the portion where the main part 330 and the sub-part 310 overlap each other supports the main part 330 by using a relatively small volume of the sub-part 310. Therefore, the sub-part 310 may provide an additional supporting force in the bladder part 300 while the fluid is being sucked (i.e., taken or drawn in, injected, or the like) or after the fluid is completely sucked (i.e., after the bladder part 300 is completely filled by the fluid).

In an embodiment, the outer plate 100 may be fixedly coupled to the seat frame F that defines an external shape of the vehicle seat. The seat frame F may include any one of or both a seat back frame and a seat cushion frame. The outer plate 100 may be provided on any one of or both the seat back frame and the seat cushion frame.

In other words, when the air support system including the outer plate 100 is provided on the seat back frame, the inner plate 500 may be positioned at a backrest upper end portion and serve as a shoulder bolster that supports two opposite sides of the user's shoulder when the bladder part 300 expands. This may improve traveling stability by supporting the user's upper body so that the user's upper body is tightly in contact to, and fully supported by, the seat when rapid cornering or swaying of the vehicle body occurs.

In contrast, when the air support system including the outer plate 100 is provided on the seat cushion frame, the air support system may serve as a side bolster that supports the user's buttocks and two opposite sides of the user's waist. Even when the vehicle body tilts leftward and rightward or rapidly rotates, this structure assists in maintaining the state where the user's body is tightly in contact to, and fully supported by, the seat. In addition, this structure provides a resistive force against a sway of the vehicle by increasing a close-contact force between the seat and the user's body. Therefore, it is possible to further improve the user's comfort and safety while the vehicle travels.

As described above, the air support system including the outer plate 100 is a structure that may serve as various bolsters (i.e., shoulder bolster and/or side bolster) in accordance with particular frame positions of the seat. Therefore, the air support system provides a customized supporting force and stability that suits the user's body type and the traveling situation.

In an embodiment, the bladder part 300 may be structured to rotate the inner plate 500 by sucking in (i.e., intaking, supplying or drawing in) or discharging fluid. When the internal pressure is increased by the sucked in fluid as the bladder part 300 expands, the internal pressure pushes the protruding portions 501 of the inner plate 500 and initiates a rotational motion. In one example, an expansion degree and an expansion speed of the bladder part 300 may be adjusted in accordance with the amount of sucked in fluid, such that a rotation angle may be finely adjusted to meet the user's needs.

In contrast, when the bladder part 300 is contracted by the discharged fluid, the internal pressure is reduced. When the internal pressure is reduced, the inner plate 500 may be returned to an original position or the rotation of the inner plate 500 may be stopped. This process may be automatically adjusted to change the user's posture or to ensure stability, thereby contributing immediate supporting force and stability even while the vehicle travels.

Therefore, the bladder part 300 controls the rotation of the inner plate 500 by intaking and discharging the fluid. Therefore, the air support system acts as the main operational principle to provide a customized supporting force to the user.

In an embodiment, a plurality of recessed spaces 101 may be formed in the outer plate 100, and a plurality of protruding portions 501 may be formed on the inner plate 500 that correspond to the recessed spaces 101. The protruding portions 501 are disposed in association with the corresponding recessed spaces 101. The sub-part 310 includes a plurality of sub-cushions expanded by the sucked in or supplied fluid. The sub-cushion is disposed for each of the recessed spaces 101 of the outer plate 100 and induces the rotation of the inner plate 500.

The main part 330 includes a main cushion expanded by the sucked in or supplied fluid, and the main cushion may expand by receiving the supplied fluid from the sub-cushion. After the sub-cushion expands first, pushes the protruding portions 501, and initiates the rotation of the inner plate 500, the sucked in or supplied fluid is transmitted from the sub-cushion to the main cushion, such that the main part 330 expands. Therefore, the main part 330 provides an additional supporting force and assists in stably supporting the user's body.

As illustrated in FIG. 6, a pneumatic part 700 is provided inside the bladder part 300 and configured to supply or discharge the fluid. The pneumatic part 700 may be connected to the sub-part 310 of the bladder part 300 and configured to supply the fluid to the sub-part 310 or discharge the fluid accommodated in the sub-part 310.

The pneumatic part 700 serves to induce an initial rotation of the inner plate 500 by quickly controlling the expansion and contraction of the sub-part 310. When the fluid is supplied to the sub-part 310, the sub-part 310 may quickly expand even by a relatively small amount of fluid, and the sub-part 310 may initiate the rotation by pushing the protruding portions 501 of the inner plate 500. Thereafter, when the fluid is additionally supplied to the main part 330, the entire bladder part 300 expands and provides a stable supporting force.

In contrast, when the fluid accommodated in the sub-part 310 is discharged through the pneumatic part 700, the sub-part 310 may quickly contract to stop the rotation of the inner plate 500 or induce the inner plate 500 to return to the original position. Therefore, the bladder part 300 may optimize the stability by quickly responding to a request to change and support the user's posture.

In addition, in an embodiment, the pneumatic part 700 may include a pump 710 configured to pressurize and transmit the fluid. The pneumatic part 700 may also include a tube 720 configured to supply the pressurized fluid to the inside of the bladder part 300 or discharge the fluid accommodated in the bladder part 300.

The pump 710 may serve to pressurize the fluid to a desired pressure and supply the fluid to the bladder part 300. The pump 710 may quickly induce the expansion of the bladder part 300 by pressurizing the fluid, thereby adjusting the fluid pressure in accordance with the user's need. Therefore, the bladder part 300 may expand and contract at an appropriate rate, thereby adjusting the responsiveness of the air support system.

The tube 720 serves as a passageway that supplies the fluid, which is pressurized by the pump 710, to the inside of the bladder part 300 or discharges the fluid, which is accommodated in the bladder part 300, to the outside. The tube 720 is designed to partition routes, through which the fluid is transmitted to the sub-part 310 and the main part 330 of the bladder part 300, in order to accurately supply the fluid to a necessary portion or discharge the fluid. In particular, the fluid may be supplied or discharged to or from the sub-part 310, such that the inner plate 500 may be quickly rotated.

In an embodiment, the pneumatic part 700 may further include a valve connected to the tube 720, and a valve controller 730 configured to supply fluid to the inside of the bladder part 300 or discharge the fluid accommodated in the bladder part 300 by adjusting an opening degree of the valve.

The valve is connected to the tube 720 of the pneumatic part 700 and serves as an entrance or exit that transmits the fluid to the bladder part 300 or discharges the fluid. In other words, because the pump 710 serves to pressurize the fluid to a necessary pressure and supply the fluid to the bladder part 300, the pump 710 is connected to the valve, and a flow of the fluid is controlled by the valve before the fluid is transmitted to the bladder part 300 through the tube 720. When the pump 710 operates, the pressurized fluid moves toward the valve, and the valve opens or closes a movement route for the fluid, such that the flow of the fluid toward the bladder part 300 is controlled. For example, when the valve is closed, the fluid in the pump 710 is not transmitted to the bladder part 300. When the valve is opened, the fluid pressurized by the pump 710 may be supplied to the bladder part 300.

The valve is designed to adjust a change in pressure in the bladder part 300. When the fluid is sucked in or supplied, the valve is opened so that the fluid is smoothly supplied to the bladder part 300. When the bladder part 300 is completely filled by the fluid, the valve is closed. When the bladder part 300 discharges the fluid, the valve is opened so that the fluid is effectively discharged.

The valve controller 730 refers to a device configured to adjust the opening degree of the valve. The valve controller 730 serves to supply the fluid with an accurate amount at an accurate rate to the inside of the bladder part 300 or discharge the fluid accommodated in the bladder part 300. In other words, the valve controller 730 controls the expansion and contraction of the bladder part 300. The valve controller 730 may operate in conjunction with a control system in the vehicle and adjust the pressure in the bladder part 300 depending on the traveling situation of the vehicle, thereby changing a degree to which the inner plate 500 supports the user.

As illustrated in FIG. 7, the bladder part 300 may be formed as the sub-part 310 is thermally bonded to the main part 330, and the sub-part 310 and the main part 330 may communicate with each other through a thermally bonded portion H. The thermally bonded portion H is structured to connect the two parts 310 and 330 so that the fluid may flow in the two parts 310 and 330 while sealability is maintained. The thermally bonded portion H assists the fluid in smoothly flowing in the bladder part 300.

Because the sub-part 310 and the main part 330 are coupled by thermal bonding, the durability and stability of the bladder part 300 may be reinforced. In other words, the stable structure may be maintained even though expansion and contraction are repeated while the vehicle travels. In addition, the communication structure through the thermally bonded portion H may allow the fluid to freely move between the sub-part 310 and the main part 330 and more effectively distribute the supporting force in accordance with the change in the user's body or the traveling situation.

With the thermal bonding and communication structure, the bladder part 300 may provide a more consistent supporting force and contribute to improving the performance of the air support system.

While the specific embodiments of the present disclosure have been illustrated and described, it should be obvious to those having ordinary skill in the art that the present disclosure may be variously modified and changed without departing from the technical spirit of the present disclosure defined in the appended claims.

What is claimed is:

1. An air support system comprising:
an outer plate having a lateral portion in which a recessed space is formed;
an inner plate hingedly coupled to the outer plate and configured to be rotatable about the outer plate, the inner plate having a protruding portion protruding toward the recessed space of the outer plate; and
a bladder part provided between the outer plate and the inner plate and comprising:
a sub-part disposed within the recessed space of the outer plate; and
a main part disposed on a lower surface of the inner plate,
wherein the inner plate is configured to rotate based on expansion of the sub-part.

2. The air support system of claim 1, wherein the outer plate is fixedly coupled to a seat frame that defines an external shape of a seat.

3. The air support system of claim 1, wherein the outer plate is provided on a seat back frame, a seat cushion frame, or both the seat back frame and the seat cushion frame.

4. The air support system of claim 1, wherein the bladder part is configured to rotate the inner plate by supplying or discharging a fluid.

5. The air support system of claim 1, comprising:
a pneumatic part configured to supply a fluid into the bladder part or discharge the fluid accommodated in the bladder part,
wherein the pneumatic part is connected to the sub-part of the bladder part and supplies the fluid to the sub-part or discharges the fluid accommodated in the sub-part.

6. The air support system of claim 5, wherein the pneumatic part comprises:
a pump configured to pressurize and transmit the fluid; and
a tube configured to supply the fluid pressurized from the pump into the bladder part or discharge the fluid accommodated in the bladder part.

7. The air support system of claim 6, wherein the pneumatic part further comprises:
a valve connected to the tube; and
a valve controller configured to supply the fluid into the bladder part or discharge the fluid accommodated in the bladder part by adjusting an opening degree of the valve.

8. The air support system of claim 5, wherein the sub-part is configured to expand by the fluid being supplied to the sub-part, and thereby push the protruding portion of the inner plate, such that the inner plate begins to rotate.

9. The air support system of claim 8, wherein the main part is configured to expand after the sub-part is supplied with the fluid, and wherein, after the main part is expanded, the inner plate is supported by the main part.

10. The air support system of claim 1, wherein the sub-part is thermally bonded to the main part, such that the sub-part and the main part communicate with each other through a thermally bonded portion.

11. The air support system of claim 1, wherein the recessed space includes a plurality of recessed spaces, the plurality of recessed spaces being formed in the outer plate,
wherein the protruding portion includes a plurality of protruding portions, the plurality of protruding portions being formed on the inner plate and corresponding in number to the plurality of recessed spaces,
wherein the sub-part comprises a plurality of sub-cushions configured to be expanded by a supplied fluid, the plurality of sub-cushions being respectively disposed in the plurality of recessed spaces, and
wherein the main part comprises a main cushion configured to be expanded by the supplied fluid, the main cushion being configured to receive the supplied fluid from the plurality of sub-cushions.

12. The air support system of claim 11, wherein the plurality of sub-cushions are thermally bonded to the main cushion to constitute the bladder part, such that the plurality of sub-cushions and the main cushion communicate with one another through the thermally bonded portion.

13. The air support system of claim 1, wherein the sub-part has a smaller cross-sectional area than the main part.
